(19) United States
(12) Patent Application Publication
(10) Pub. No.: US 2022/0255463 A1
(43) Pub. Date: Aug. 11, 2022

(54) ARTIFICIAL AIR GAP TRIBOELECTRIC DEVICE FOR APPLICATIONS IN SENSORS, POWER GENERATION AND ENERGY HARVESTING

(71) Applicant: LAWRENCE LIVERMORE NATIONAL SECURITY, LLC, Livermore, CA (US)

(72) Inventors: Logan Bekker, Pleasanton, CA (US); Caitlyn C. Cook, Livermore, CA (US); Joshua D. Kuntz, Livermore, CA (US); Elaine Lee, Oakland, CA (US); Erik V. Mukerjee, Dublin, CA (US); Andrew J. Pascall, Livermore, CA (US); Marcus A. Worsley, Hayward, CA (US); Jenny Zhou, San Francisco, CA (US)

(21) Appl. No.: 17/308,627

(22) Filed: May 5, 2021

Related U.S. Application Data
(60) Provisional application No. 63/148,053, filed on Feb. 10, 2021.

(51) Int. Cl. H02N 1/04; H02N 1/00

(52) U.S. Cl. CPC H02N 1/04; H02N 1/006

(57) ABSTRACT

A triboelectric device artificial air gap between the two materials to create the voltage potential. A method of using a flexible, compressive material as a spacer to create an artificial air gap that will allow the two materials to transfer electrons and provide a restorative force to separate the two materials when pressed together. The result is a device that does not require an air gap to generate a voltage potential, which in turn reduces the necessary footprint of the triboelectric device to a thin film and improves its mechanical robustness and lifetime.

### CROSS-REFERENCE TO RELATED APPLICATIONS

This application claims priority to and benefit under 35 U.S.C. § 119(e) of U.S. Provisional Patent Application No. 63/148,053 filed Feb. 10, 2021 entitled “artificial air gap triboelectric device for applications in sensors, power generation and energy harvesting,” the content of which is hereby incorporated by reference in its entirety for all purposes.

### STATEMENT AS TO RIGHTS TO APPLICATIONS MADE UNDER FEDERALLY SPONSORED RESEARCH AND DEVELOPMENT

The United States Government has rights in this application pursuant to Contract No. DE-AC52-07NA27344 between the United States Department of Energy and Lawrence Livermore National Security, LLC for the operation of Lawrence Livermore National Laboratory.

### BACKGROUND

### Field of Endeavor

The present application relates to triboelectricity and more particularly to an artificial air gap between a first triboelectricity material and a second triboelectricity material.

### State of Technology

This section provides background information related to the present disclosure which is not necessarily prior art.

Triboelectricity is the utilization of what is essentially static electricity that is generated between two materials when they come into frictional contact. The underlying principle that causes this electrification is electrostatic induction which is when electrons from one material move to another. The ease of electrons to move is based on the dissimilar polarity between the two materials and can be determined based on the triboelectric series which was developed to list the polarity of numerous materials. When the two materials are separated, the electrons that moved remain behind and as the distance between the materials increases, a voltage potential is generated. By shorting the two materials with a wire, the electrons can move back to the original material (driving current) and equalize the potential. Small, low powered electronics can be powered with the current and voltage potential created by the materials.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

The inventors disclose an artificial air gap between a first triboelectricity material and a second triboelectricity material. In one embodiment, the artificial air gap is a flexible, compressive material as a spacer to create an artificial air gap that will allow the two materials to transfer electrons and provide a restorative force to separate the two materials when pressed together. The result is a device that does not require an air gap to generate a voltage potential, which in turn reduces the necessary footprint of the triboelectric device to a thin film and improves its mechanical robustness and lifetime.

Applications of a flexible thin film triboelectric device include use as a sensor, a thin film triboelectric device could be applied to surfaces of materials to record touch (force) or impact. They could also be impregnated into materials as an embedded sensor. If a biocompatible material combination is used, there are applications in the biomedical field as implantable sensors into patients or on the surface of the skin as vital sensors. A thin film energy harvesting device could be used to collect waste/ambient energy from mechanical systems or harvest energy from green sources such as wind or water. Additionally, the adaptation into a thin film could allow the energy harvester to be embedded into clothing as a wearable. As an on-board power supply, the device could be used to power electrophoretic displays (EPD), LEDs or small low-power electronic equipment such as momentary data logging or momentary lighting.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serve to explain the principles of the apparatus, systems, and methods.

FIG. 1 is an illustration that provides background and prior art information regarding Applicant's apparatus, systems, and methods.

FIG. 2 is an illustrative view of one embodiment of Applicant's apparatus, systems, and methods.

FIG. 3 is an illustration that provides a basis for descriptions of various embodiments of Applicant's apparatus, systems, and methods.

FIGS. 4-7 are illustrations that provide descriptions of various embodiments of Applicant's apparatus, systems, and methods.

FIGS. 8 and 9 show an example of the inventor's apparatus, systems, and methods incorporated into a touch screen device.

FIGS. 10A, 10B, and 10C are illustrative views of a temperature sensing embodiment of Applicant's apparatus, systems, and methods.

FIGS. 11A and 11B are illustrative views of a wearable bend sensor worn like a glove embodiment of Applicant's apparatus, systems, and methods.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

Triboelectricity is the utilization of what is essentially static electricity that is generated between two materials when they come into frictional contact. The underlying principle that causes this electrification is electrostatic induction which is when electrons from one material move to another. The ease of electrons to move is based on the dissimilar polarity between the two materials and can be determined based on the triboelectric series which was developed to list the polarity of numerous materials.

When the two materials are separated, the electrons that moved remain behind and as the distance between the materials increases, a voltage potential is generated. By shorting the two materials with a wire, the electrons can move back to the original material (driving current) and equalize the potential. Small, low powered electronics can be powered with the current and voltage potential created by the materials.

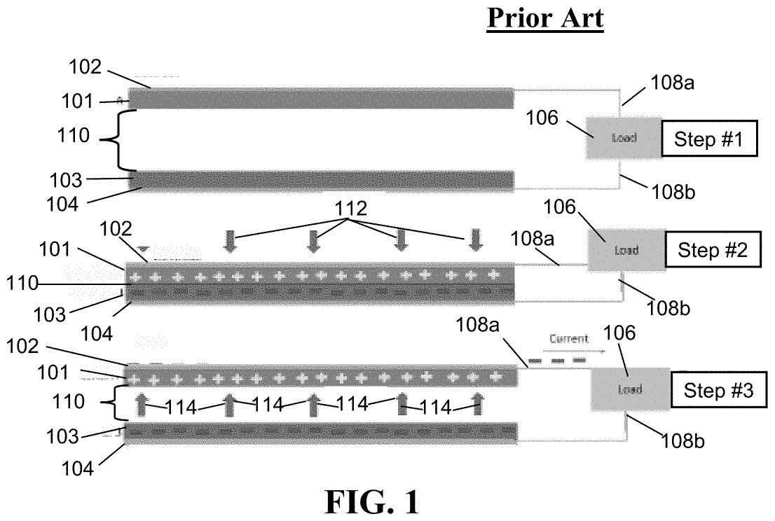

Referring now to the drawings, and in particular to FIG. 1, background and prior art information regarding Applicant's apparatus, systems, and methods are illustrated by a flow chart. The flow chart includes Step #1, Step #2, and Step #3 and structural components 101, 102, 103, 104, 106, 108a, 108b, 110, 112, and 114. The structural components are described in greater detail below.

101—Material A—Material A is a “most positive+” material in the triboelectric series that ranks various materials according to their tendency to gain or lose electrons and reflects the natural physical property of materials.

102—Material A Electrode—An electrode attached to Material A.

103—Material B—Material B is a “most negative+” material in the triboelectric series that ranks various materials according to their tendency to gain or lose electrons and reflects the natural physical property of materials.

104—Material B Electrode—An electrode attached to Material B.

106—Load—The portion of the circuit that consumes power.

108a—Electrical Connection A—An electrical connection between Electrode A and the “Load,”

108b—Electrical Connection B—An electrical connection between Electrode B and the “Load,”

110—Air Gap—An empty space between Material A and Material B that is filled with air,

112—Arrows showing collapse of the device, and

114—Arrows showing expansion of the device.

The identification and description of the background and prior art information flow chart of FIG. 1 having been completed, the operation and additional description of the background and prior art information flow chart will now be considered in greater detail.

Flow Chart Step #1—In step #1, the Material A 101 and Material B 101 are positioned in a position separated by air gap 110. No charge is flowing. Electron charge is at equilibrium.

Flow Chart Step #2—In step #2, Material A and Material B are moved through air gap 110 into contact with each other. Electrostatic induction occurs where some electrons move from Material B 103 into Material A 101 (in this instance, Material A is the electron receiver and B is the donator). While in contact they reach a state of electron equilibrium.

Flow Chart Step #3—In step #3, Material A 101 and Material B 103 are separated which results in an unequal distribution of electrons still remaining in Material A. When looking at Material A 101 and Material B 103 there is a voltage potential between the two now due to the electron imbalance. Electrical current will now run through an electronic load 106 that may be powered. When the circuit is closed (as it is currently in the diagram) the electrons are able to move from Material A 101 back to Material B 103 through the wire (driving a current through the load) and return the materials to electron equilibrium and discharging the voltage potential between the two materials. Components 108a and 108b represent wires that lead from the electrodes 102 and 104 on the backs of Material A 101 and Material B 103.

The two primary methods for actuating triboelectric devices are through contact separation and lateral sliding. Applicant's apparatus, systems, and methods expands upon the contact separation mode. With contact separation, there is a vertical displacement (air gap) between the two materials that generates the voltage potential between the two materials. Because air is an insulator, the electron balance cannot equalize, and the surfaces of the materials become charged. The air gap in these devices reduces the utility of these devices and constrains their application.

Supplementing a non-conductive material between the two materials allows the charge imbalance to occur between the material without an air gap, resulting in a flexible, self-contained device. The material can be made of an elastomeric material, porous, capable of being compressed and creating its own restorative force when the compression source is removed. As the material is compressed, the two triboelectric materials are brought into close proximity to allow the electron transfer to occur. When the compression source is removed, the restorative force of the material would create the voltage potential by separating the two materials.

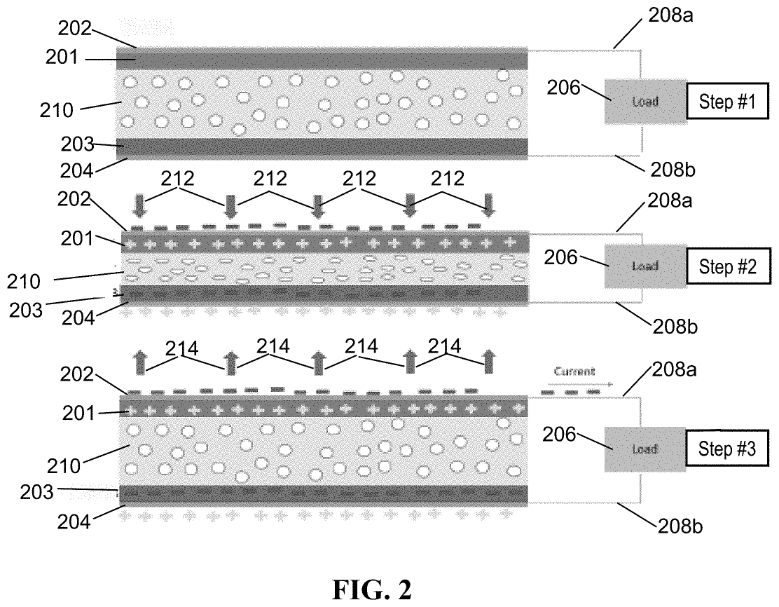

Referring again to the drawings, and now to FIG. 2, an embodiment of Applicant's apparatus, systems, and methods is illustrated by a flow chart. The flow chart includes Step #1, Step #2, and Step #3 and operational structural components 201, 202, 203, 204, 206, 208a, 208b, 210, 212, and 214. The operational structural components are described in greater detail below.

201—Material A—Material A is a “most positive+” material in the triboelectric series that ranks various materials according to their tendency to gain or lose electrons and reflects the natural physical property of materials and also any other material that is not in the triboelectric series wherein the material has a tendency to gain or lose electrons.

202—Material A Electrode —An electrode attached to Material A.

203—Material B—Material B is a “most negative+” material in the triboelectric series that ranks various materials according to their tendency to gain or lose electrons and reflects the natural physical property of materials and also any other material not in the triboelectric series that has a tendency to gain or lose electrons.

204—Material B Electrode—An electrode attached to Material B.

206—Load—The portion of the circuit that consumes power.

208a—Electrical Connection A—An electrical connection between Electrode A and the “Load,”

208b—Electrical Connection B—An electrical connection between Electrode B and the “Load,”

210—Artificial Air Gap—A flexible and compressive material as a spacer capable of being compressed and creating its own restorative force when the compression source is removed,

212—Arrows showing collapse of the device, and

214—Arrows showing expansion of the device.

The identification and description of one embodiment of Applicant's apparatus, systems, and methods having been completed, the operation and additional description of the device will now be considered in greater detail.

Initially, the Material A 201 and Material B 203 are located in a position separated by Artificial Air Gap 210 as shown in Flow Chart Step #1. Material A Electrode 202 attached to Material A and Material B Electrode 204 attached to Material B are connected through Electrical Connection A 208a and Connection B 208b to the “Load” 206. No charge is flowing. Electron charge is at equilibrium. The Air Gap 210 is a material that is flexible and compressive used as a spacer between Material A 201 and Material B 203. The Air Gap 210 material is capable of being compressed and creating its own restorative force when the compression source is removed.

As illustrated in Flow Chart Step #2, Material A 201 and Material B 203 are moved through Artificial Air Gap 210 into contact with each other by an external force illustrated by arrows 212. Electrostatic induction occurs where some electrons move from Material B 203 into Material A 201 (in this instance, Material A is the electron receiver and B is the donator). While in contact they reach a state of electron equilibrium.

As illustrated in Flow Chart Step #3, Material A 201 and Material B 203 are separated by an external force illustrated by arrows 214 which results in an unequal distribution of electrons still remaining in Material A. When looking at Material A and B there is a voltage potential between the two now due to the electron imbalance. Items 208a and 208b represent wires that lead from the electrodes on the backs of Material A and Material B. Electrical current will now run through an electronic load 206 that may be powered. When the circuit is closed (as it is currently in the diagram) the electrons are able to move from Material A back to Material B through the wire (driving a current through the load) and return the materials to electron equilibrium and discharging the voltage potential between the two materials.

The Artificial Air Gap 210 material between Material A and Material B allows the charge imbalance to occur between the material without an air gap, resulting in a flexible, self-contained device. The Artificial Air Gap 210 is made of an elastomeric material, porous, capable of being compressed and creating its own restorative force when the compression source is removed. As the material is compressed, the two triboelectric materials are brought into close proximity to allow the electron transfer to occur. When the compression source is removed, the restorative force of the material would create the voltage potential by separating the two materials.

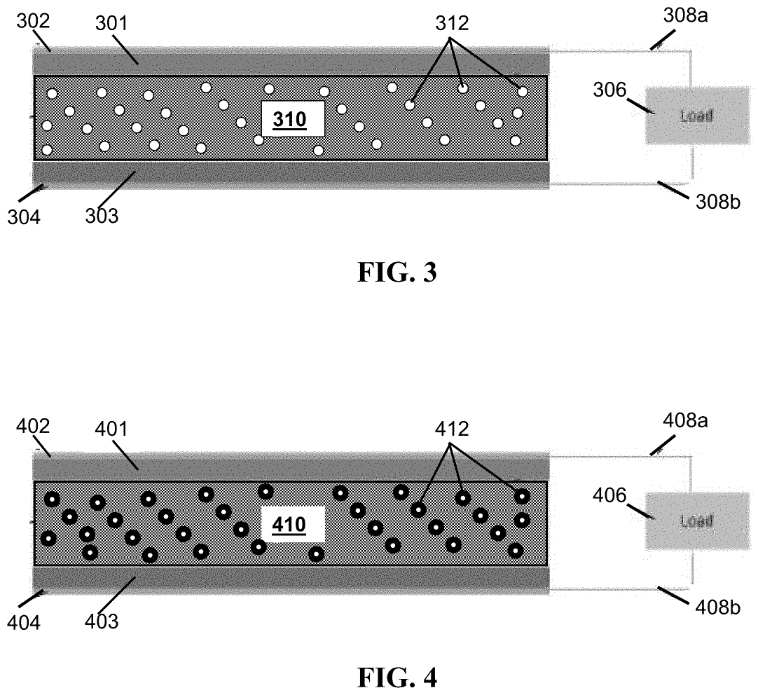

Referring now to FIG. 3, an illustration shows one embodiment of Applicant's Artificial Air Gap. As shown in FIG. 3, Artificial Air Gap 310 is located between Material A 301 and Material B 303. Material A Electrode 302 is attached to Material A and Material B Electrode 304 is attached to Material B. The two electrodes are connected through Electrical Connection A 308a and Connection B 308b to the “Load” 306. The Air Gap 310 is a material that is flexible and compressive used as a spacer between Material A 301 and Material B 303. The Air Gap 310 material is capable of being compressed and creating its own restorative force when the compression source is removed.

As the Artificial Air Gap 310 material is compressed, the two triboelectric materials (Material A 301 and Material B 303) are brought into close proximity to allow the electron transfer to occur. When the compression source is removed, the restorative force of the material creates a voltage potential by separating the two materials, Material A 301 and Material B 303. As described in connection with FIG. 2, Material A 301 and Material B 303 are moved through Artificial Air Gap 310 into contact with each other by an external force. Electrostatic induction occurs where some electrons move from Material B 303 into Material A 301. While in contact they reach a state of electron equilibrium. Next, Material A 301 and Material B 303 are separated by an external force which results in an unequal distribution of electrons still remaining in Material A. There is a voltage potential between the two now due to the electron imbalance.

Artificial Air Gap Polyurethane Material Example

In the Example the Artificial Air Gap material 310 is a Polyurethane material with pores 312. The Artificial Air Gap material 310 is be made porous by adding salt prior to curing. When it is cured, the polyurethane is swelled, and the salt is dissolved with water to create manufactured pores 312 within the polyurethane matrix 310.

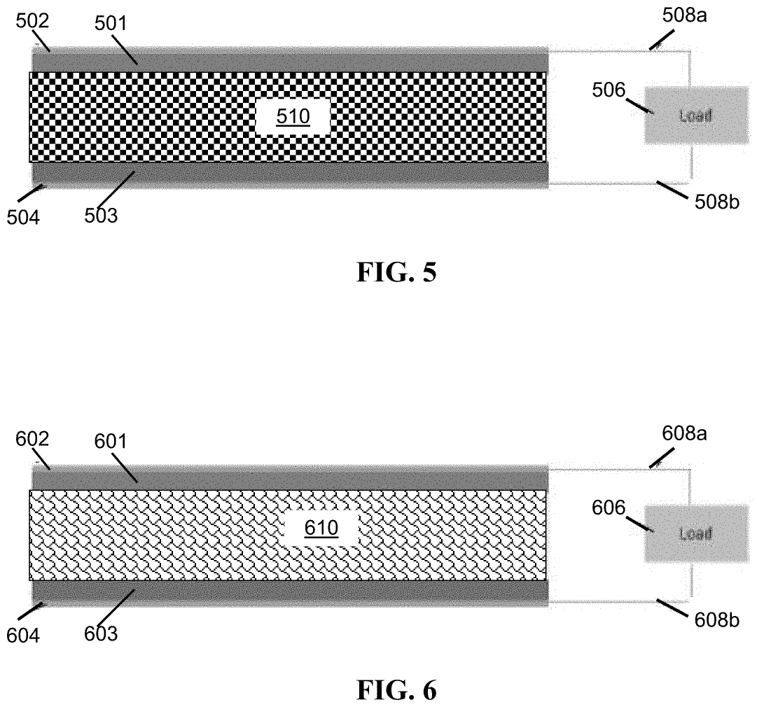

Referring now to FIG. 4, an illustration shows another embodiment of Applicant's Artificial Air Gap. As shown in FIG. 4, Artificial Air Gap 410 is located between Material A 401 and Material B 403. Material A Electrode 402 is attached to Material A and Material B Electrode 404 is attached to Material B. The two electrodes are connected through Electrical Connection A 408a and Connection B 408b to the “Load” 406. The Air Gap 410 is a material that is flexible and compressive used as a spacer between Material A 401 and Material B 403. The Air Gap 410 material is capable of being compressed and creating its own restorative force when the compression source is removed.

As the Artificial Air Gap 410 material is compressed, the two triboelectric materials (Material A 401 and Material B 403) are brought into close proximity to allow the electron transfer to occur. When the compression source is removed, the restorative force of the material creates a voltage potential by separating the two materials, Material A 401 and Material B 403. As described in connection with FIG. 2, Material A 401 and Material B 403 are moved through Artificial Air Gap 410 into contact with each other by an external force. Electrostatic induction occurs where some electrons move from Material B 403 into Material A 401. While in contact they reach a state of electron equilibrium. Next, Material A 401 and Material B 403 are separated by an external force which results in an unequal distribution of electrons still remaining in Material A. There is a voltage potential between the two now due to the electron imbalance.

Artificial Air Gap Polydimethylsiloxane Material Example

In this Example the Artificial Air Gap material 410 is a Polydimethylsiloxane material with silica beads 412. The Polydimethylsiloxane Artificial Air Gap material 410 has silica beads fillers added. The Polydimethylsiloxane Artificial Air Gap material 410 can also be made porous by adding salt prior to curing. When it is cured, the Polydimethylsiloxane is swelled, and the salt is dissolved with water to create manufactured pores within the Polydimethylsiloxane matrix.

Referring now to FIG. 5, an illustration shows another embodiment of Applicant's Artificial Air Gap. As shown in FIG. 5, Artificial Air Gap 510 is located between Material A 501 and Material B 503. Material A Electrode 502 is attached to Material A and Material B Electrode 504 is attached to Material B. The two electrodes are connected through Electrical Connection A 508a and Connection B 508b to the “Load” 506. The Air Gap 510 is a material that is flexible and compressive used as a spacer between Material A 501 and Material B 503. The Air Gap 510 material is capable of being compressed and creating its own restorative force when the compression source is removed.

As the Artificial Air Gap 510 material is compressed, the two triboelectric materials (Material A 501 and Material B 503) are brought into close proximity to allow the electron transfer to occur. When the compression source is removed, the restorative force of the material creates a voltage potential by separating the two materials, Material A 501 and Material B 503. As described in connection with FIG. 2, Material A 501 and Material B 503 are moved through Artificial Air Gap 510 into contact with each other by an external force. Electrostatic induction occurs where some electrons move from Material B 503 into Material A 501. While in contact they reach a state of electron equilibrium. Next, Material A 501 and Material B 503 are separated by an external force which results in an unequal distribution of electrons still remaining in Material A. There is a voltage potential between the two now due to the electron imbalance.

Artificial Air Gap Polybutadiene Material Example

In this Example the Artificial Air Gap material 510 is a Polybutadiene material. Polybutadiene is a synthetic rubber known for its robustness. The Polybutadiene Artificial Air Gap material 510 can have fillers added. The Polybutadiene Artificial Air Gap material 510 can also be made to create manufactured pores within the Polybutadiene matrix.

Referring now to FIG. 6, an illustration shows another embodiment of Applicant's Artificial Air Gap. As shown in FIG. 6, Artificial Air Gap 610 is located between Material A 601 and Material B 603. Material A Electrode 602 is attached to Material A and Material B Electrode 604 is attached to Material B. The two electrodes are connected through Electrical Connection A 608a and Connection B 608b to the “Load” 606. The Air Gap 610 is a material that is flexible and compressive used as a spacer between Material A 601 and Material B 603. The Air Gap 610 material is capable of being compressed and creating its own restorative force when the compression source is removed.

As the Artificial Air Gap 610 material is compressed, the two triboelectric materials (Material A 601 and Material B 603) are brought into close proximity to allow the electron transfer to occur. When the compression source is removed, the restorative force of the material creates a voltage potential by separating the two materials, Material A 601 and Material B 603. As described in connection with FIG. 2, Material A 601 and Material B 603 are moved through Artificial Air Gap 610 into contact with each other by an external force. Electrostatic induction occurs where some electrons move from Material B 603 into Material A 601. While in contact they reach a state of electron equilibrium. Next, Material A 601 and Material B 603 are separated by an external force which results in an unequal distribution of electrons still remaining in Material A. There is a voltage potential between the two now due to the electron imbalance.

Artificial Air Gap Aerogel Material Example

In this Example the Artificial Air Gap material 610 is an Aerogel material. The Aerogel Artificial Air Gap material 610 can have fillers added. Aerogels-contain nanopores and can have dielectric behavior of a gas rather than a solid.

Electro-spun porous elastomer-electrospinning process would create pores as the thin fiber is spun onto the surface.

Referring now to FIG. 7, an illustration shows the electrodes used with Applicant's Artificial Air Gap. As shown in FIG. 7, Material A Electrode 702 is attached to Material A and Material B Electrode 704 is attached to Material B. The two electrodes are connected through Electrical Connection A 708a and Connection B 708b to the “Load” 706. The Air Gap 710 is a material that is flexible and compressive used as a spacer between Material A 701 and Material B 703. The Air Gap 710 material is capable of being compressed and creating its own restorative force when the compression source is removed.

Electrode Material Examples

In the first Example the electrode material is silver conductive ink. silver conductive ink is semiflexible and highly conductive.

In the second Example the electrode material is a conductive polymer-PEDOT:PSSm a common conductive polymer used in screen printed electronics.

In the third Example the electrode materials are conductive polymers with nanoparticle composites.

In the fourth Example the electrode materials are Indium Tin Oxide (ITO).

In the fifth Example the electrode materials are Fluorine doped Tin Oxide (FTO)-conductive with light to pattern the response.

In the sixth Example the electrode materials are standard metal electrodes-gold, copper etc.

The electrodes used with Applicant's Artificial Air Gap are made by Applying electrodes using Screen printing, roll to roll/gravure, spray coating, and other processes.

Touch Screen Device Example

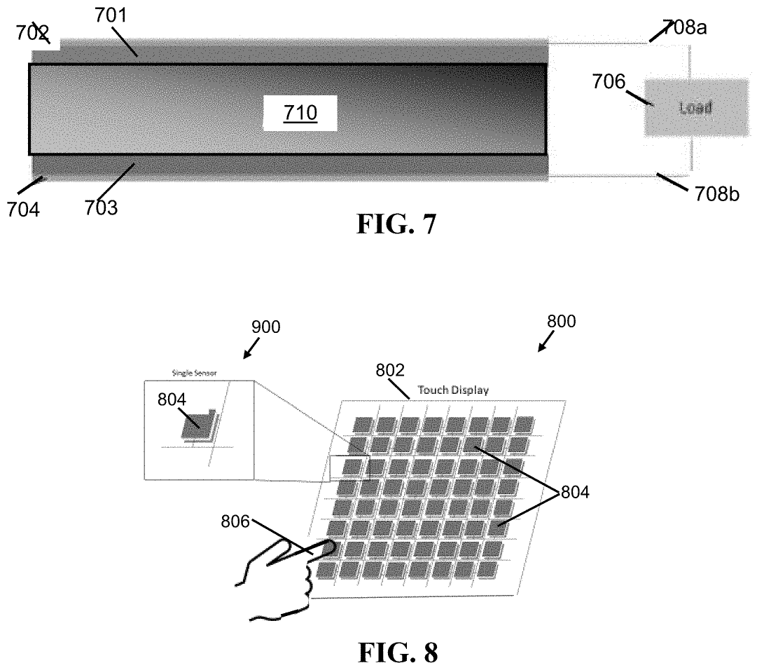

Referring now to FIGS. 8 and 9, illustrations show an example of the inventor's apparatus, systems, and methods incorporated into a touch screen device. Referring specifically to FIG. 8, an illustrative view shows a touch screen device embodiment of Applicants' apparatus, systems, and methods. This embodiment is identified generally by the reference numeral 800. An enlarged view designated by the reference numeral 900 shows an individual sensor section of the touch screen display. The components of Applicants' touch screen device 800 in FIG. 8 are listed below.

802—touch screen display,

804—individual sensor sections of the touch screen display,

804—hand shown activating an individual sensor section of the touch screen display, and

900—an enlarged view showing an individual sensor section of the touch screen display.

The description of the structural components of the Applicants' touch screen device embodiment 800 having been completed, the operation and additional description of the Applicants touch screen device embodiment will now be considered in greater detail. The inventor's triboelectric touch screen device 800 has a touch screen display 802. The touch screen display 802 is divided into individual sensor sections 804. The individual sensor sections 804 can be any of the devices illustrated in FIGS. 2-7 described above. Section 900 is an enlarged view of one of the individual sensor sections 804.

Referring now to FIG. 9, the individual sensor section 804 of the touch screen display 802 is illustrated and described in greater detail. The individual sensor section is designated generally by the reference numeral 900. The portion of FIG. 9 labeled “START” shows the individual sensor section 804/900 in the initial position before the hand 804 show in FIG. 8 depresses the individual sensor section 804 of the touch screen display 802. The individual sensor section 804/900 includes the components of listed below.
901—Material A—Material A is a “most positive+” material in the triboelectric series that ranks various materials according to their tendency to gain or lose electrons and reflects the natural physical property of materials and also any other material that is not in the triboelectric series wherein the material has a tendency to gain or lose electrons.
902—Material A Electrode—An electrode attached to Material A.
903—Material B—Material B is a “most negative+” material in the triboelectric series that ranks various materials according to their tendency to gain or lose electrons and reflects the natural physical property of materials and also any other material not in the triboelectric series that has a tendency to gain or lose electrons.
904—Material B Electrode—An electrode attached to Material B.
906—Load—The portion of the circuit that consumes power.
908a—Electrical Connection A—An electrical connection between Electrode A and the “Load,”
908b—Electrical Connection B—An electrical connection between Electrode B and the “Load,” and
910—Artificial Air Gap—A flexible and compressive material as a spacer capable of being compressed and creating its own restorative force when the compression source is removed.

Initially, the Material A 901 and Material B 903 are located in a position separated by Artificial Air Gap 910. Material A Electrode 902 attached to Material A and Material B Electrode 904 attached to Material B are connected through Electrical Connection A 908a and Connection B 908b to the “Load” 906. No charge is flowing. Electron charge is at equilibrium. The Air Gap 910 is a material that is flexible and compressive used as a spacer between Material A 901 and Material B 903. The Air Gap 910 material is capable of being compressed and creating its own restorative force when the compression source is removed.

Next, the hand 804 show in FIG. 8 depresses the individual sensor section 804 of the touch screen display 802. This moves the sensor 804 to the position illustrated in the portion of FIG. 9 labeled “COMPRESSED OR BENDED.” Material A 901 and Material B 903 are moved to depress Artificial Air Gap 910 until they are nearly in contact with each other by the force of the hand 804 show in FIG. 8 depressing the sensor section 804. This is illustrated by arrows 912 and 914. Electrostatic induction occurs where some electrons move from Material B 903 into Material A 901 (in this instance, Material A is the electron receiver and B is the donator). While in contact they reach a state of electron equilibrium.

Next, the hand 804 show in FIG. 8 releases the individual sensor section 804 of the touch screen display 802. This moves the sensor 804 to the position illustrated in the portion of FIG. 9 labeled “RELEASED.” When looking at Material A and B there is a voltage potential between the two now due to the electron imbalance. Items 908a and 908b represent wires that lead from the electrodes on the backs of Material A and Material B. Electrical current will now run through the electronic load 906. The current can be used to provide a signal and can be used to power the device 900.

The Artificial Air Gap 910 material is made of an elastomeric material, porous, capable of being compressed and creating its own restorative force when the compression source is removed. As the material is compressed, the two triboelectric materials are brought into close proximity to allow the electron transfer to occur. When the compression source is removed, the restorative force of the material would create the voltage potential by separating the two materials.

Temperature Sensor Device Example

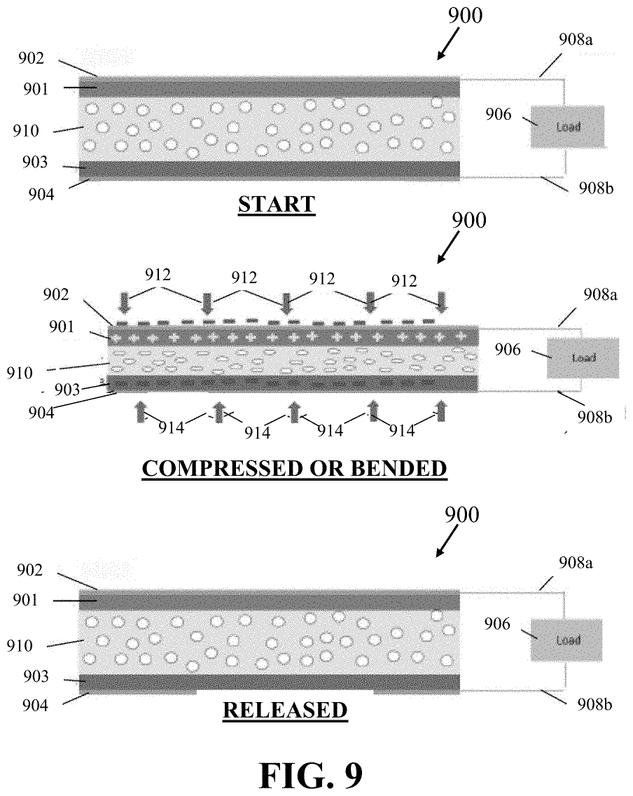

Referring now to FIGS. 10A, 10B, and 10C, illustrative views show a temperature sensor embodiment of Applicant's apparatus, systems, and methods. This embodiment is identified generally by the reference numeral 1000. The components of Applicant's temperature sensor embodiment 1000 in 10A, 10B, and 10C are listed below.

1002—elastomer/gap material, and

1004—force applied.

The description of the structural components of the Applicants' temperature sensor embodiment 1000 having been completed, the operation and additional description of the Applicants temperature sensor embodiment will now be considered in greater detail. Applicants' temperature sensor embodiment 1000 includes the operational components (including triboelectricity material and electrodes) illustrated and described in the various embodiments above. The elastomer/gap material 1002 operates the way the Artificial Air Gap illustrated and described in the various embodiments above.

Referring now to FIG. 10A, the temperature sensor 1000 is shown in its steady state condition. The triboelectricity material and electrodes are located in their respective positions and are separated by the elastomer/gap material 1002 in a relaxed condition.

Referring now to FIG. 10B, a predetermined standard pressure force 104 is applied to the elastomer/gap material 1002. As the ambient temperature changes the elastomer/gap material 1002 will change in modulus and act as a stronger or weaker spring when pressed. Increased ambient temperature relaxes elastomer and makes actuation easier. The electrical output of the temperature sensor 1000 is directly related to state of the elastomer/gap material 1002. A predetermined standard pressure force 104 is applied to the elastomer/gap material 1002 and the electrical output is a measurement of temperature.

Referring now to FIG. 10C, a predetermined standard pressure force 104 is applied to the elastomer/gap material 1002. Reduced temperature causes elastomer to stiffen and require more force to actuate device. If a freezing temperature is reach or a temperature that is the freezing temp for the elastomer/gap material 1002 the temperature sensor 1000 would no longer generate power when pressed and there would be no electrical output.

Wearable Bend Sensor Device Example

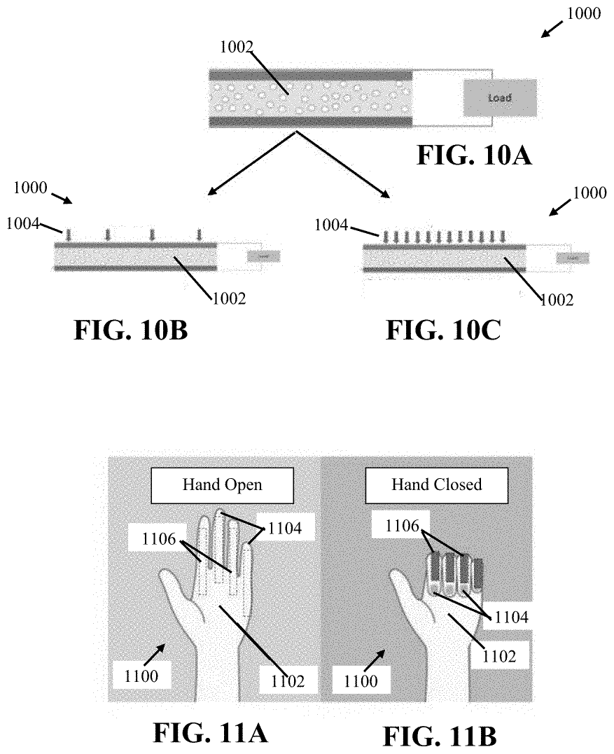

Referring now to FIGS. 11A and 11B, illustrative views show a wearable bend sensor embodiment of Applicants' apparatus, systems, and methods. This embodiment is identified generally by the reference numeral 1100. The components of Applicants' wearable bend sensor 1100 in FIGS. 11A and 11B are listed below.

1102—hand (alternatively a glove),

1104—fingers, and

1106—bend sensor.

The description of the structural components of the Applicants' wearable bend sensor embodiment 1100 having been completed, the operation and additional description of Applicants wearable bend sensor embodiment will now be considered in greater detail. The inventor's triboelectric wearable bend sensor is either attached to the back of the hand 1102 or worn like a glove. The sensor sections 1106 can be any of the devices illustrated in FIGS. 2-9 described above. When the fingers 1104 are bent a voltage can be read by the sensor 1106. This enables identification of which part of the sensor is bent. For example, if only one finger is bent a voltage can be read by the sensor.

The artificial air gap encompasses the use of a flexible, compressive material as a spacer to create an artificial air gap that will allow the two materials to transfer electrons and provide a restorative force to separate the two materials when pressed together. The non-conductive material between the two materials allows the charge imbalance to occur between the material without an air gap, resulting in a flexible, self-contained device, probably of smaller volume than a standard triboelectric device that generates the same amount of power. The gap material is an elastomeric material, porous, capable of being compressed, and creating its own restorative force when the compression source is removed. As the material is compressed, the two triboelectric materials are brought into close proximity to allow the electron transfer to occur. When the compression source is removed, the restorative force of the material creates the voltage potential by separating the two materials.

With respect to other gapless triboelectric devices, it is believed that the restorative property of the gap material will increase the power output of the device. Some examples of a flexible thin film triboelectric device are described below.

As a sensor. A thin film triboelectric device is applied to surfaces of materials to record touch (force) or impact. They can be impregnated into materials as an embedded sensor. If a biocompatible material combination is used, there are applications in the biomedical field as implantable sensors into patients or on the surface of the skin as vital sensors.

As a thin film energy harvesting device. The triboelectric device can be used to collect waste/ambient energy from mechanical systems or harvest energy from green sources such as wind or water. Additionally, the adaptation into a thin film allows the energy harvester to be embedded into clothing as a wearable device.

As an on-board power supply. The device can be used to power electrophoretic displays (EPD), LEDs or small low-power electronic equipment such as momentary data logging or momentary lighting.

This application covers all modifications, equivalents, and alternatives falling within the spirit and scope of the apparatus, systems, and methods as defined by the claims.

Although the description above contains many details and specifics, these should not be construed as limiting the scope of the application but as merely providing illustrations of some of the presently preferred embodiments of the apparatus, systems, and methods. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

1. A triboelectricity apparatus, comprising:
first triboelectricity material,
second triboelectricity material, and
an artificial air gap between said first triboelectricity material and said second triboelectricity material.

2. The triboelectricity apparatus of claim 1 wherein said artificial air gap between said first triboelectricity material and said second triboelectricity material is made of flexible and compressive material.

3. The triboelectricity apparatus of claim 1 wherein said artificial air gap between said first triboelectricity material and said second triboelectricity material is a spacer capable of being compressed and creating its own restorative force when the compression source is removed

4. The triboelectricity apparatus of claim 1 wherein said first triboelectricity material is a “most positive+” material in the triboelectric series that ranks various materials according to their tendency to gain or lose electrons and reflects the natural physical property of materials or a material not in the triboelectric series that has a tendency to gain or lose electrons.

5. The triboelectricity apparatus of claim 1 wherein said first triboelectricity material is a “most positive+” material in the triboelectric series that ranks various materials according to their tendency to gain or lose electrons and reflects the natural physical property of materials.

6. The triboelectricity apparatus of claim 1 wherein said first triboelectricity material is a material not in the triboelectric series that has a tendency to gain or lose electrons.

7. The triboelectricity apparatus of claim 1 wherein said first triboelectricity material is a “most negative+” material in the triboelectric series that ranks various materials according to their tendency to gain or lose electrons and reflects the natural physical property of materials or a material not in the triboelectric series that has a tendency to gain or lose electrons.

8. The triboelectricity apparatus of claim 1 wherein said first triboelectricity material is a “most negative+” material in the triboelectric series that ranks various materials according to their tendency to gain or lose electrons and reflects the natural physical property of materials.

9. The triboelectricity apparatus of claim 1 wherein said first triboelectricity material is a material not in the triboelectric series that has a tendency to gain or lose electrons.

10. The triboelectricity apparatus of claim 1 wherein said an artificial air gap is made of a polyurethane material.

11. The triboelectricity apparatus of claim 1 wherein said an artificial air gap is made of a polyurethane material containing pores.

12. The triboelectricity apparatus of claim 1 wherein said an artificial air gap is made of a Polydimethylsiloxane material.

13. The triboelectricity apparatus of claim 1 wherein said an artificial air gap is made of a Polydimethylsiloxane material with manufactured pores.

14. The triboelectricity apparatus of claim 1 wherein said an artificial air gap is made of a Polydimethylsiloxane material with silica beads.

15. The triboelectricity apparatus of claim 1 wherein said an artificial air gap is made of an Aerogel material.

16. The triboelectricity apparatus of claim 1 wherein said an artificial air gap is made of an Aerogel material containing pores.

17. A triboelectricity apparatus, comprising:
first triboelectricity material,
a first electrode attached to said first triboelectricity material,
second triboelectricity material,
a second electrode attached to said second triboelectricity material, and
an artificial air gap between said first triboelectricity material and said second triboelectricity material.

18. The triboelectricity apparatus of claim 17 wherein said first electrode is silver conductive ink. silver conductive ink is semiflexible and highly conductive.

19. The triboelectricity apparatus of claim 17 wherein said first electrode is a conductive polymer-PEDOT.

20. The triboelectricity apparatus of claim 17 wherein said first electrode is a conductive polymer.

21. The triboelectricity apparatus of claim 17 wherein said first electrode is a conductive polymer with nanoparticle composites.

22. The triboelectricity apparatus of claim 17 wherein said first electrode is Indium Tin Oxide (ITO).

23. The triboelectricity apparatus of claim 17 wherein said first electrode is Fluorine doped Tin Oxide (FTO).

24. A triboelectricity method, comprising the steps of:
providing a first triboelectricity material,
providing a second triboelectricity material, and
providing an artificial air gap between said first triboelectricity material and said second triboelectricity material.
